(19) United States
(12) Patent Application Publication
(10) Pub. No.: US 2015/0128757 A1
(43) Pub. Date: May 14, 2015

(54) FLYWHEEL

(71) Applicant: TECHNISCHE UNIVERSITAET WIEN, Vienna (AT)

(72) Inventors: Alexander Schulz, Vienna (AT); Thomas Hinterdorfer, Vienna (AT); Harald Sima, Herzogenburg (AT); Johann Wassermann, Vienna (AT); Manfred Neumann, Vienna (AT)

(21) Appl. No.: 14/401,420

(22) PCT Filed: May 13, 2013
(86) PCT No.: PCT/AT2013/050106

§ 371 Date: Nov. 14, 2014

(30) Foreign Application Priority Data
May 15, 2012 (AT) A 50183/2012

(51) Int. Cl. F16F 15/30; H02K 7/02

(52) U.S. Cl. CPC F16F 15/30; H02K 7/025
USPC 74/572.21

(57) ABSTRACT

Disclosed is a flywheel (13) comprising a rotating element (13′) which rotates in relation to an axis of rotation and includes a radially outer flywheel mass member (24) that adjoins an inner shaft connection part (26) and tapers in the radial direction such that hollow projecting end pieces (24′) are formed. The external face of the outer flywheel mass member (24) has a radial indentation (25) that extends all around the flywheel mass member.

The invention relates to a flywheel with a rotating element that rotates in relation to an axis of rotation, which exhibits a radially outer flywheel mass member that tapers in the radial direction and adjoins an inner shaft connection member, wherein hollow projecting end pieces are formed.

Such a flywheel is known from McGroarty et al., “Flywheel Energy Storage System for Electric Start and an All-Electric Ship”, Electric Ship Technologies Symposium, 2005 IEEE, pp. 400-406, Jul. 25-27, 2005.

Also known from DE 196 51 668 A1 is a flywheel for high rotational speeds. In this flywheel, a flywheel mass generally resembling a hollow cone joins to a shaft at an inclination. At high speeds, this may cause gaping at the joint between the flywheel mass and shaft.

Further known from US 2010/0231075 A1 is a flywheel with a hollow cylindrical flywheel mass, which is joined to a shaft via a hollow hub. The hollow nub is intended to enable a flexible attachment to the shaft, wherein an in particular electromagnetic bearing in combination with a superconductive bearing is provided for the shaft. US 2010/0206126 A1 discloses a similar flywheel with a general hollow cylindrical flywheel mass, which is joined to the shaft by means of a generally shell-shaped, separate hub, which allows relative movements between the shaft and flywheel mass. Then known from U.S. Pat. No. 5,628,232 A is a flywheel, again with a hollow cylindrical flywheel mass, wherein this flywheel mass is secured to a shaft via a hub shaped like a hollow cone. As with the flywheels described above, the disadvantage here involves a complicated manufacturing process, in that a flywheel mass and a separate hub must be individually provided, and especially made out of different materials.

Flywheels are used in rotating machines, in particular electric motors/generators, for storing energy, and comprise the central component of a flywheel energy storage system, FESS (flywheel energy storage system) for short. Due to its shape and mass, the rotor has a significant influence on the energy content and energy density (energy content per mass), on the overall costs of the system, and on the power dissipation of the bearing. In light of the outstanding material properties, flywheels are made out of composite materials (most often carbon fiber composite materials, CFK, or a combination of CFK and glass fiber composite materials, GFK). These materials exhibit outstanding material properties in the fiber direction, but only a low strength transverse to the fiber direction, thereby yielding a suboptimal material utilization for many conventional rotor designs, since very high mass forces act in a radial direction.

In rotor designs, a distinction can basically be made between an internal and external rotor. In the internal rotor, a solid shaft acts as the carrier for bearing and motor/generator components. In the external rotor, a hollow shaft is used, and the electrical machine and the bearing engage the inner radius of the hollow shaft.

As mentioned, flywheels made out of fiber-reinforced materials and having rectangular (axial) cross sections are used in commercially available flywheels apart from the internal rotors made entirely out of steel and most often having a rectangular flywheel mass cross section. Another known rotor design involves an internal rotor with an H-shaped cross section and composite flywheel mass.

Current research projects are generally focused on rotors made out of fiber composite materials (carbon fibers, glass fibers). These again include internal rotors with a rectangular cross section (Herbst et al., “Design, Fabrication, and Testing of 10 MJ Composite Flywheel Energy Storage Rotors, SAE Technical Paper 981282, 1998; Jansen et al., “G2 Flywheel Module Design”, NA-SA/CR-2006-213862) or with an H-shaped cross section (Park et al., “Development of 5 kWh flywheel energy storage system using MAT-LAB/xPC Target”, World Congress on Computer Science and Information Engineering 2008 IEEE, (2009): pp. 701-705; McGroarty et al., “Flywheel Energy Storage System for Electric Start and an All-Electric Ship”, Electric Ship Technologies Symposium, 2005 IEEE, pp. 400-406, Jul. 25-27, 2005.

The external rotor exhibits a completely different structural design. In place of a shaft, the latter has a central stator unit, which is encircled by the flywheel mass. The most common cross sectional shape for this rotor design is rectangular (e.g., Beno et al., “End-of-life design for composite rotors”, IEEE Transactions on Magnetics, 37 (1) (2001): 284-289) or H-shaped.

In this structural design, given a configuration with magnetic bearings, the general problem is that the air gap of the magnetic bearing as well as of the motor/generator increases due to the arising expansion of the rotor. In order to ensure a sufficient air gap even at a minimum speed, a significantly larger air gap thus comes about at a maximum speed, which leads to a reduction in energy efficiency because of the required larger magnetomotive force, or to a power reduction. Another major problem involves the nearly direct contact between the motor/generator and the composite material. The lost heat of the magnetically soft motor/generator rotor can only be released via radiation anyway in light of the vacuum; in addition, composites can only be exposed to a low temperature load. Furthermore, the carrier structure poses a big challenge in terms of its construction. The comparatively large inner radius also gives rise to very high stresses in the metal.

Taking into account only the functionality of the flywheel mass and not the motor/generator and bearing functionality, the theoretically ideal design for a flywheel rotor is a thin-walled hollow cylinder made out of composite material as the external rotor, whose interior accommodates the bearing in the upper and lower areas, and the motor/generator in the middle. This is because only slight radial stresses can form in a thin-walled hollow cylinder, so that the largest stresses arise in the circumferential direction, and thus in the fiber direction (see Arnold et al., “Deformation and life analysis of composite flywheel disk system”, Composites: Part B 33 (2002): 433-459).

Based upon the problems outlined above, the typical rotor shape for modern flywheel structures is most often an internal rotor comprised of a metal shaft used to secure the bearing and motor/generator modules, and a cylindrical or H-shaped composite material flywheel, joined to the shaft by an annular connecting or joining part.

In an H-shaped rotor viewed in an axial section, a majority of the mass is situated far to the outside to achieve the highest possible moment of inertia. The arising characteristic frequencies here limit a junction with a very small axial length relative to the length of the cylindrical flywheel member. The areas exposed to the highest load are here located at the height of the junction, since the largest mass forces come about here. High stresses arise at the transition from the joining part to the hollow cylinder due to the state of bending stress. The outer areas of the H-shape where the largest percentage moments of inertia can be achieved are only exposed to a slight load. As a direct consequence, only inadequate use can be made of the strength properties of the composite material given the geometries for the flywheel mass that can be fabricated with conventional production methods. This gives rise to higher material costs and, in light of the heavier flywheel mass, larger required dimensions for the bearing; this again yields higher costs and reduced energy efficiency for the bearing.

An object of the invention is now to propose a design for a flywheel as indicated at the outset in which the highest possible energy density can be achieved depending on the material and dimensioning, and which enables good material utilization or use of material strength properties.

The inventive flywheel of the kind mentioned at the outset is characterized in that the external face of the outer flywheel mass member exhibits a radial indentation that extends all around. As explained below, this radial indentation leads to a significant rise in energy density, both for internal and external rotor configurations.

Advantageous embodiments and further developments are indicated in the dependent claims.

It may be beneficial, for example for production reasons, for the outer flywheel mass member to exhibit a generally hollow cylindrical shape where it axially adjoins the indentation.

On the other hand, it is advantageous in terms of additionally optimizing the energy density for the outer flywheel mass to exhibit legs that generally extend outwardly at an inclination away from the center of the indentation on opposite sides as viewed in axial section. One or both of the projecting end pieces can here extend axially parallel, and thereby define a hollow cylinder.

The shaft connection part can also exhibit a smaller axial extension than the outer flywheel mass member for purposes of good space utilization in the machine (motor/generator).

A “soft” or continuous progression is best imparted primarily to the outer contour of the flywheel, but additionally or alternatively to the inner contour as well. It is here advantageous that the outside and/or inside of the flywheel mass member exhibit a contour with one or more straight segments. It is further beneficial for the outside and/or inside of the flywheel mass member to exhibit a contour with one or more curved segments. At least one circular arc segment is preferably present here. However, it is also possible to provide at least one segment that runs along a higher-order curve, e.g., an ellipse or polynomial. To make production simple, it is also advantageous for the outside and/or inside of the flywheel mass member to exhibit a stepped contour. It here also makes sense for the flywheel mass member to be designed with separate rings joined to each other.

In order to eliminate any potential imbalances, it is further advantageous for the flywheel mass member to exhibit at least one ring with receptacles, e.g., boreholes, for the attachment of balancing weights.

The design of the flywheel mass element can be symmetrical or, given a corresponding layout of accompanying system components (electrical machine, bearing), advantageously also asymmetrical in relation to its central plane (specifically the plane with the smallest outer radius). The preferred design involves a fiber composite material, in particular CFK or a combination of CKF and GFK.

From the standpoint of material utilization, the invention thus represents an advantageous structural solution for the optimal shaping of flywheels, e.g., of the kind used in FESS.

Contrary to a technically obvious configuration with the highest possible mass at a large radius, the essence of the invention involves a receding, e.g., tapering, outer contour in the shaft joining direction.

As mentioned, the outer contour is ideally designed with a “soft” or continuous progression, and consists of circular segments and straight segments, for example. Discontinuous progressions or curves of a higher order (ellipses, polynomials, etc.) are also advantageous for functional (transport restraints, etc.) and/or manufacturing reasons. In addition, the rotor needs not be symmetrical in relation to its central plane. As mentioned, the flywheel mass can further also exhibit a cascading design, wherein the rings can be separately fabricated and then joined together.

The tapering of the outer contour in the shaft joining direction reduces the mass forces in the shaft joining area, causing the radial stresses to drop. The load in the central plane area shifts in the circumferential direction, where the material strength is significantly higher. As a result, better use is made of the strength properties of the material.

It is important that, while the “absent” mass caused by the tapering of the outer contour in the shaft joining direction leads to a reduction in the moment of inertia, this makes it possible to achieve higher speeds based upon lower radial stresses. However, since the effect of increasing the speed is more crucial than the effect of reducing the moment of inertia, the energy content can be increased at the same mass. For this reason, the non-cylindrical design of the outer contour results in a better material utilization and concomitant rise in energy density.

The invention will be described in even more detail below based upon the drawing, and making reference to designs in prior art on the one hand, and to preferred, advantageous embodiments of the invention on the other. Shown on:

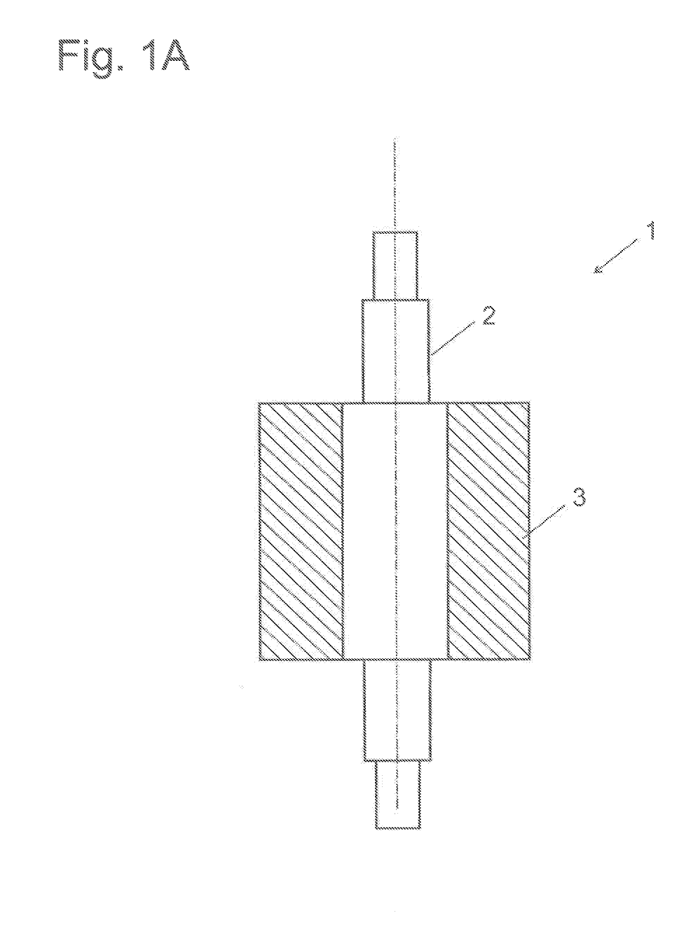

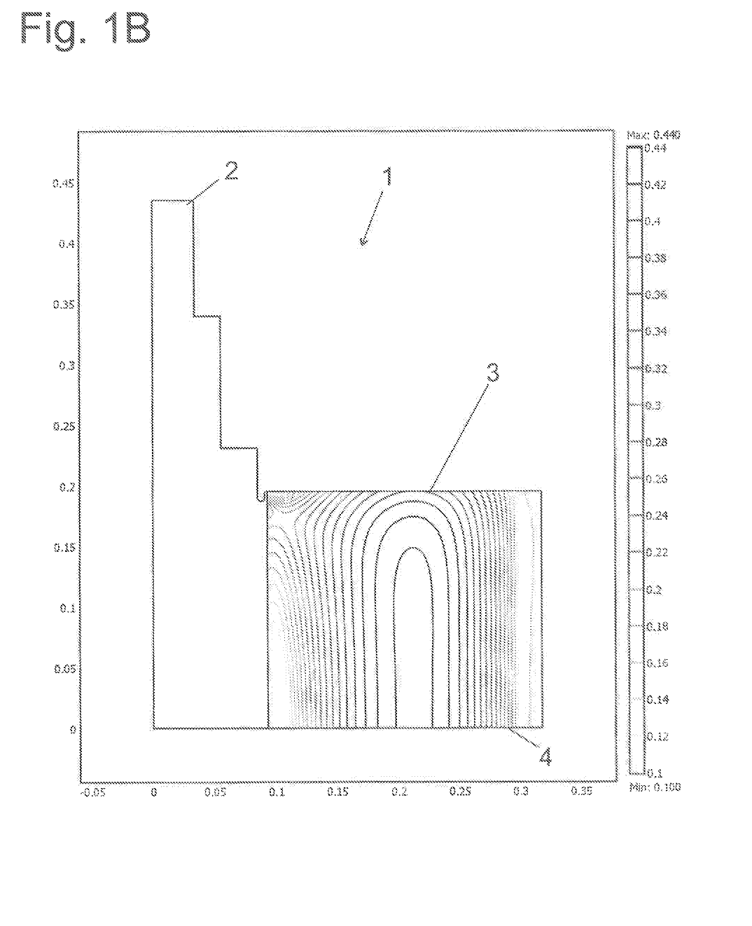

FIG. 1A is a top view of a conventional internal rotor (disc-shaped rotor);

FIG. 1B is a schematic view of an internal rotor quadrant;

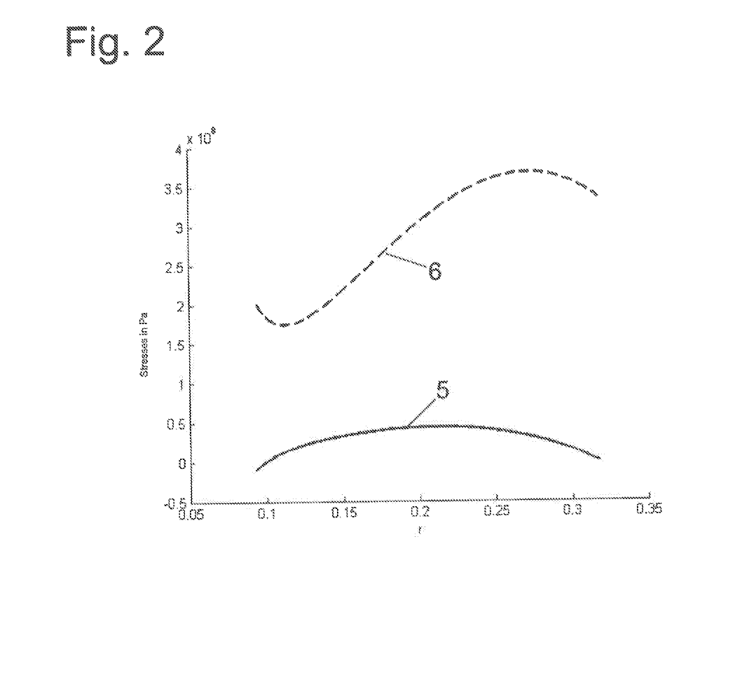

FIG. 2 is a diagram showing the radial and circumferential stress in the composite material for the internal rotor of FIG. 1B;

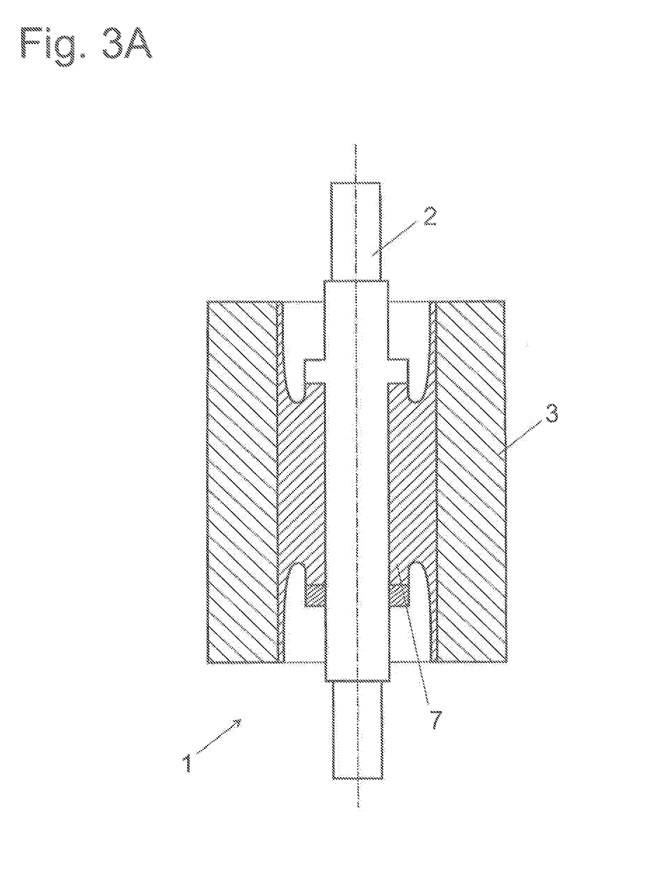

FIGS. 3A and 3B are similar depictions as on FIGS. 1A and 1B, but now for an internal rotor with an H-shaped cross section according to prior art;

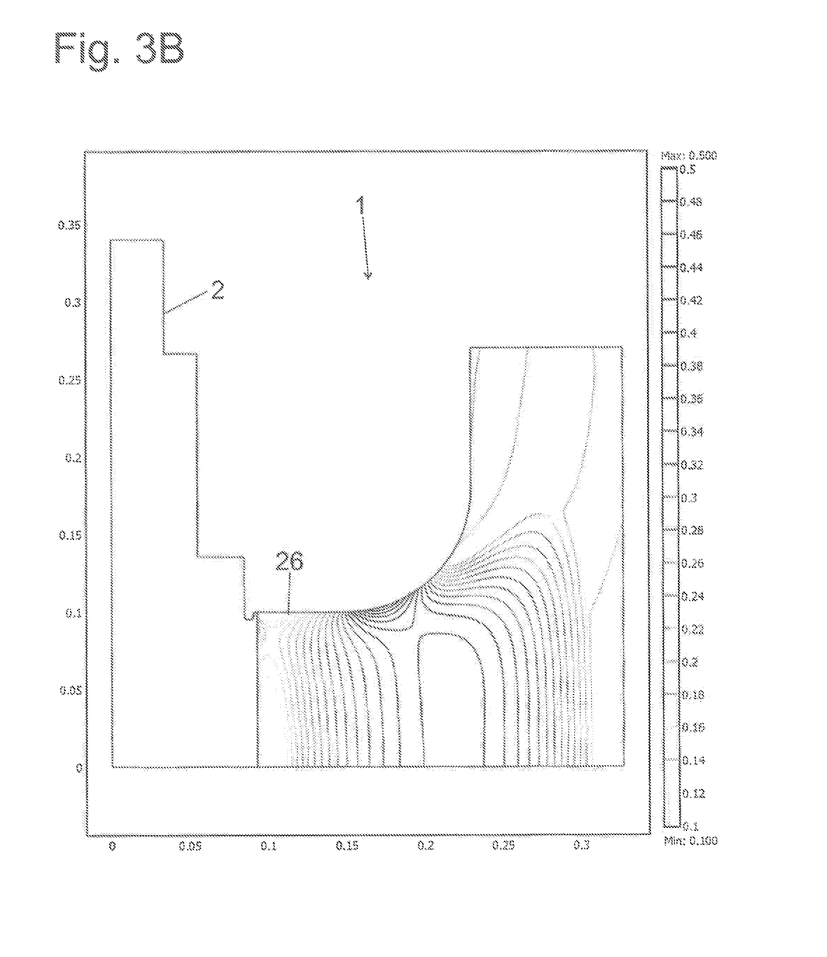

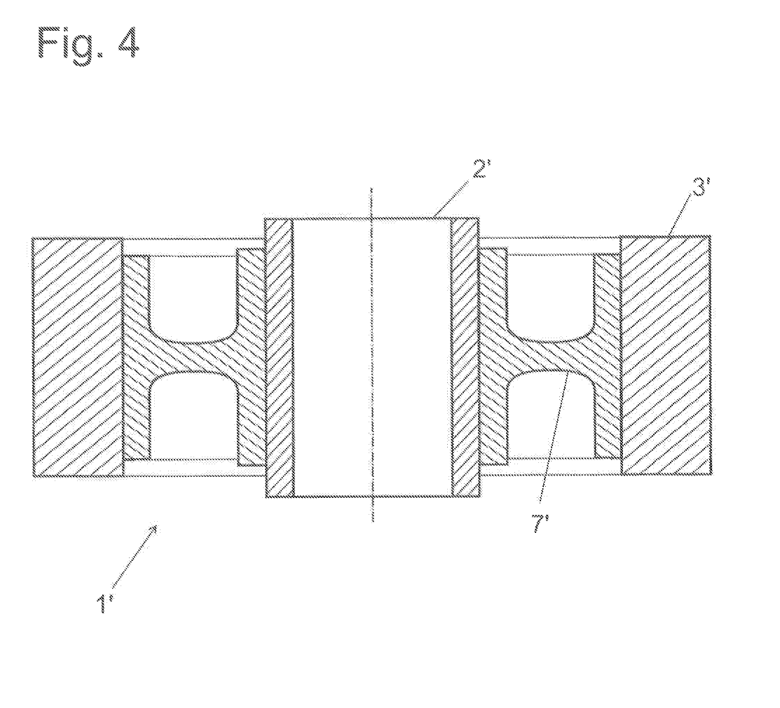

FIG. 4 is a structural design for a conventional external rotor with an H-shaped cross section;

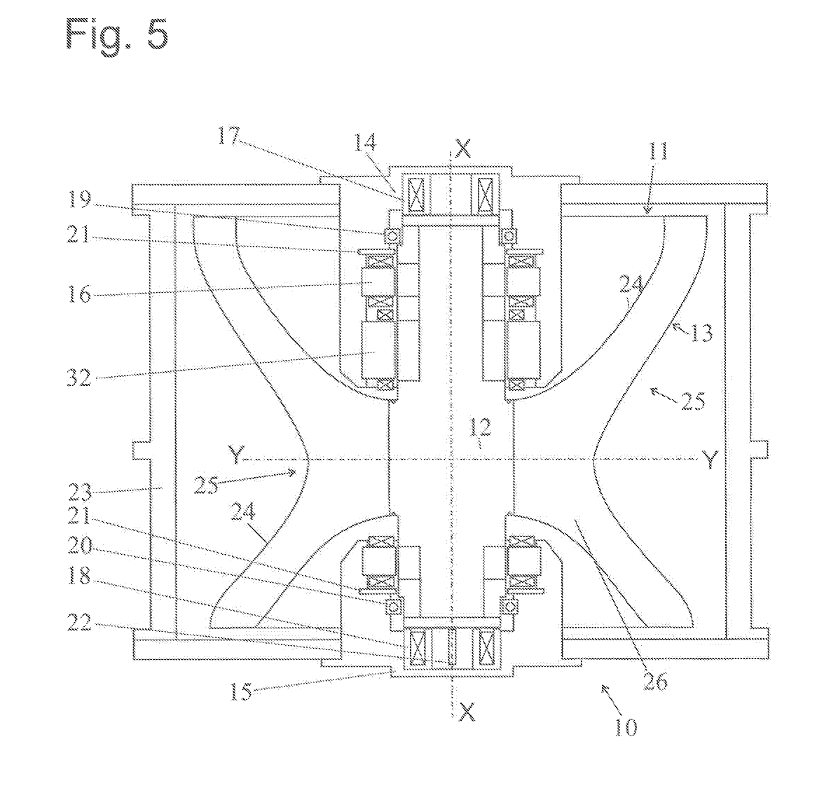

FIG. 5 is a view depicting the basic structural design for an FESS system with an internal rotor and a flywheel according to a preferred embodiment of the invention;

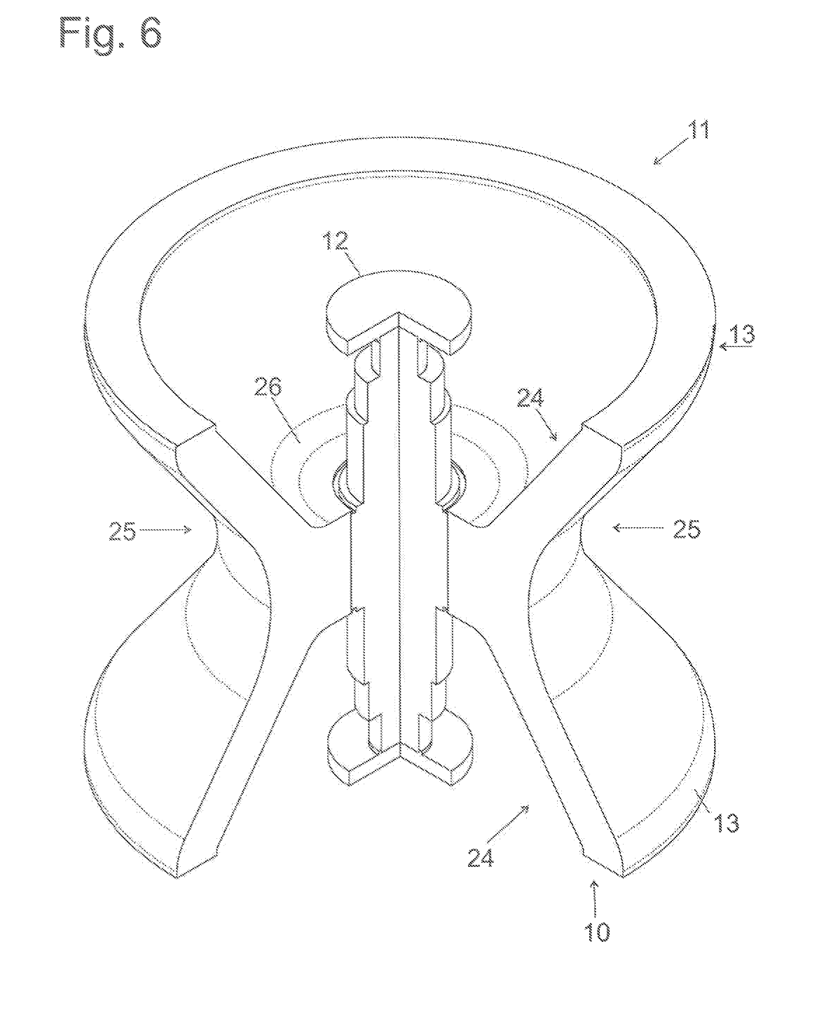

FIG. 6 is a three-dimensional view of a rotor as provided in the system according to FIG. 5, partially cut open;

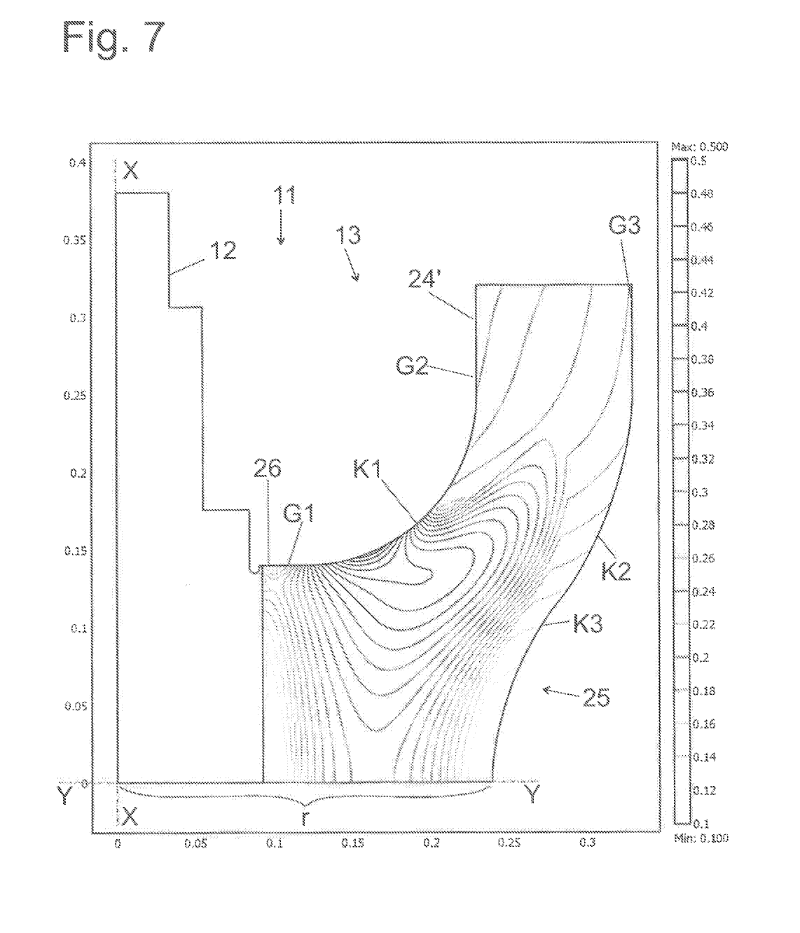

FIG. 7 is a diagram showing a quadrant of a rotor with projecting axially parallel end pieces;

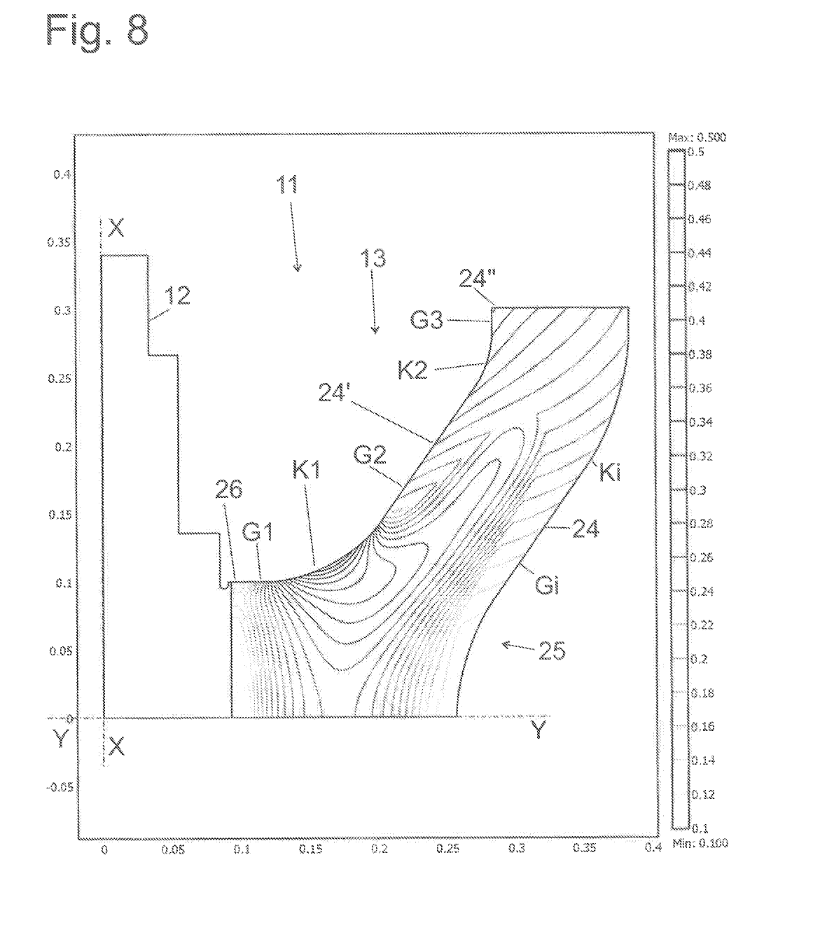

FIG. 8 is a view of a flywheel quadrant comparable to the one on FIG. 7, but now with an outwardly diverging end piece or leg;

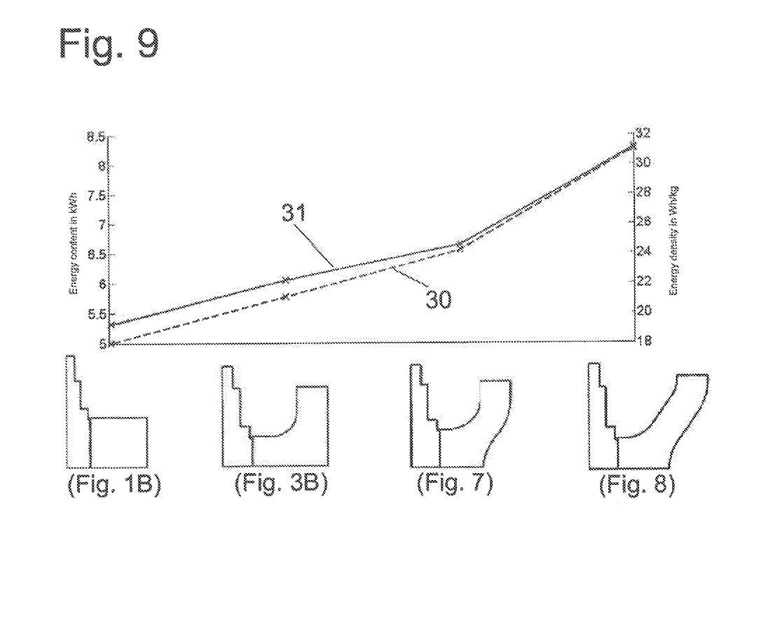

FIG. 9 is a schematic view in a common diagram comparing the energy content and energy density of the known embodiments according to FIGS. 1B and 3B on the one hand and of the embodiments according to FIGS. 7 and 8 on the other;

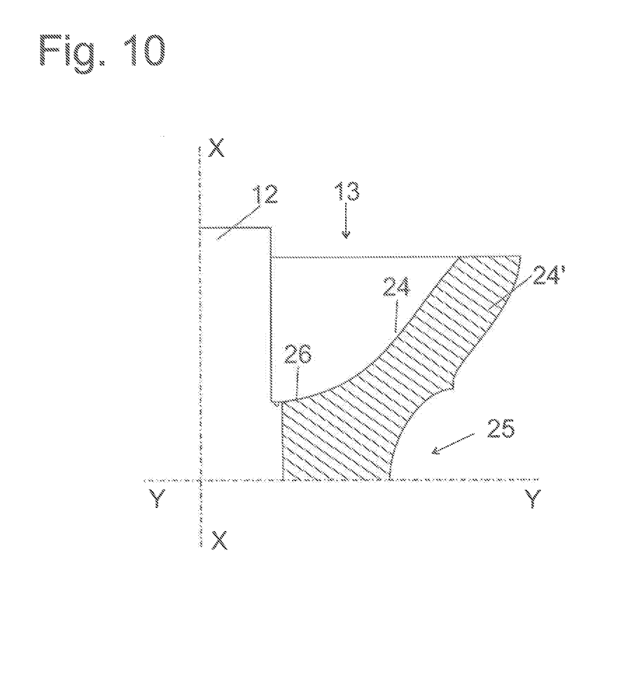

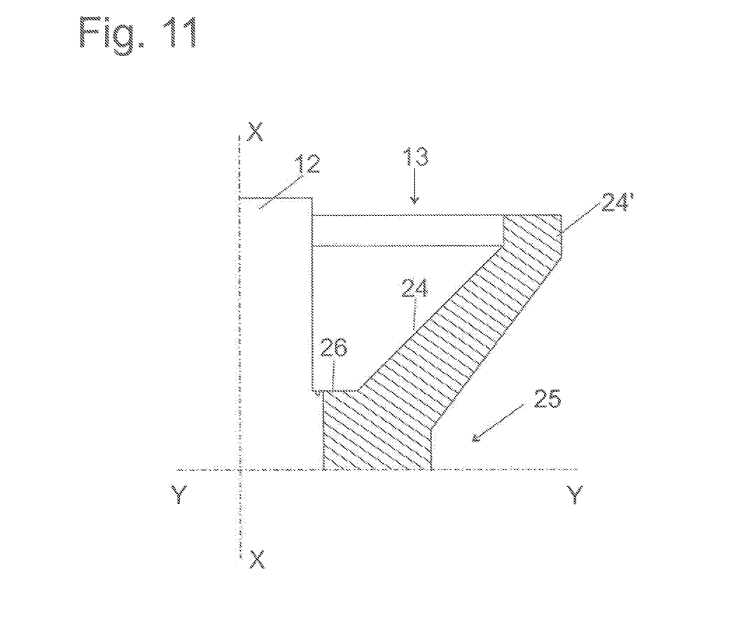

FIGS. 10 to 14 are views comparable to FIGS. 7 and 8 of further embodiments, in order to show different possible contours for the flywheel;

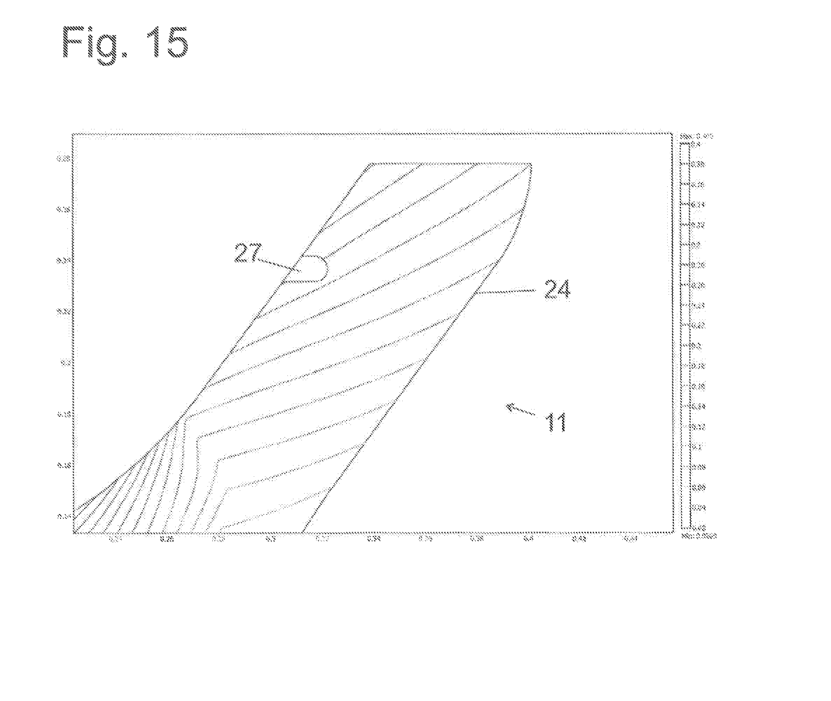

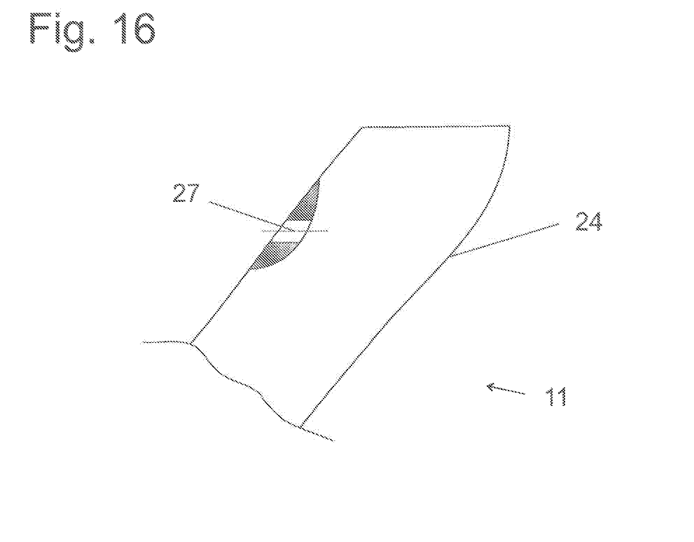

FIGS. 15 and 16 are comparable views of projecting end portions of the flywheels, with rings for accommodating balancing weights; and

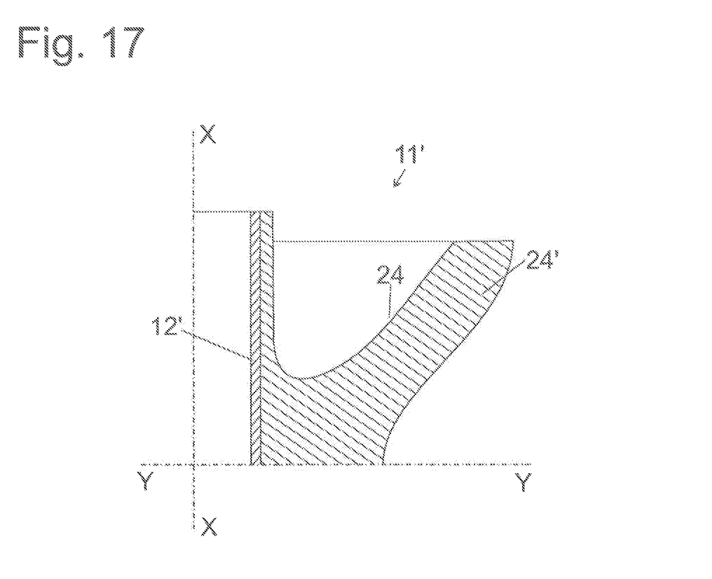

FIG. 17 is a view similar to that on FIGS. 10 to 14 showing a design as an external rotor.

FIGS. 1B, 3B, 7 and 8 show a quadrant of internal rotors, while FIG. 15 shows a projecting flywheel end piece, each with a radially symmetrical finite element simulation of the rotor, wherein lines with the same load are illustrated based on the Puck failure criterion at a maximum angular velocity, and accompanying keys are presented on the respective right edge of the screen; see Puck A., “Strength Analysis of Fiber Matrix Laminates”, models for practice, Carl Hanser Verlag Munich Vienna (1996).

FIGS. 1A to 4 relate to rotor or flywheel designs according to prior art.

FIGS. 1A and 1B show a disk-shaped rotor 1 with a shaft 2, e.g., made out of aluminum, and with a disk 3, e.g., made out of CFK, as the flywheel mass.

Table 1 below lists the most important material data for the CFK (epoxy resin-reinforced HTS40 carbon fibers from TohoTenax) and aluminum used in this and the other enumerated rotors.

TABLE 1
Material properties

| | | |
|---|---|---|
| Modulus of elasticity for the CFK in | 145 | GPa |
| the fiber direction | | |
| Modulus of elasticity for the CFK | 9 | GPa |
| transverse to the fiber direction | | |
| Density of the CFK | 1535 | kg/m³ |
| Tensile strength of the CFK in the | 2179 | MPa |
| fiber direction | | |
| Tensile strength of the CFK transverse | 98 | MPa |
| to the fiber direction | | |
| Modulus of elasticity for the aluminum | 70 | GPa |
| Density of the aluminum | 2700 | kg/m³ |
| Tensile strength of the aluminum | 275 | MPa |

FIG. 1B shows an axially symmetrical finite element simulation of rotor 1, wherein the symmetry of rotor 1 relative to its central plane 4 was used. Lines with the same load based on the Puck failure criterion at a maximum angular velocity are shown. This criterion has been standardized, i.e., failure arises at a value of 1. Since rotor 1 was dimensioned with a safety of 2, the maximum value is 0.5.

The rotor on FIG. 1B was exemplarily rated for an energy content of 5 kWh, and reaches the latter at a maximum angular velocity of 2010 rad/s. The rotor mass is 260 kg, and the moment of inertia around the axis of rotation is 9.89 kgm². These data yield an energy density of 19.23 Wh/kg. (An FESS is operated within a specific speed range to ensure an efficient operation of the electrical machine. Therefore, the energy content does not correspond to the kinetic energy. Here and in the following, let the minimum operating speed selected be equal to one third of the maximum speed.)

The highest load arises at an average radius of approx. 0.22 m, and is roughly constant in an axial direction, leaving aside edge effects, as evident from FIG. 1B. This highest load is caused by the relatively low maximum tensile strength transverse to the fiber direction for composite materials. The mass forces arising at the joining location to shaft 2 lead to high radial stresses, and hence to poor material utilization.

FIG. 2 shows the progressions of radial and circumferential stress in the composite (flywheel mass 3), and is intended to illustrate this situation. At its maximum, the radial stress 5 exhibits a safety factor of 2 relative to the maximum permissible value from Table 1, while the safety of the circumferential stress 6 depicted with dotted lines is significantly higher. As a result, insufficient use was made of the outstanding properties of the composite in the fiber direction.

The additional rotor types enumerated here are intended to provide a better comparison with the same mass as the rotor according to FIG. 1B.

FIGS. 3A and 3B present a more expedient rotor geometry (also prior art): At the same mass, a higher moment of inertia (13.18 kgm²) is achieved by an H-shaped structure; obtained as a consequence are a higher energy content of 5.7 kWh, and hence a higher energy density of 22.19 Wh/kg as well. As was the case for the structure on FIG. 1B, very high radial stresses arise at a radius of roughly 0.22 m. In addition, the projecting H-shape and its expansion result in high bending stresses at the transition, which limit the maximum achievable angular velocity (1871 rad/s).

In a schematic view similar to FIG. 1A, FIG. 4 shows a different type of rotor, an external rotor 1′, with a hollow shaft 2′ and an outer flywheel mass 3′, wherein this rotor type most commonly has a rectangular cross sectional shape. Located inside is a central stator unit (not illustrated in any greater detail), which is surrounded by the rotor or flywheel. The hollow shaft 2′ and actual flywheel mass 3′ are connected with each other by means of a joining part 7′ having an H-shaped cross section; apart from that, see also the joining part 7 according to FIG. 3A.

FIGS. 5 and 6 show an example for a flywheel energy storage system, FESS for short, 10, wherein use is made of an internal rotor 11 that comprises a shaft 12 with a axis of rotation X-X. The electrical machine (motor/generator) is labeled 32, and exhibits an outlying stator with an upper carrier sleeve 14 and a lower carrier sleeve 15 for the inherently conventional electromagnets not all designated in any greater detail, e.g., 16 for radial bearing. Also depicted are an upper axial magnetic bearing 17 and a lower axial magnetic bearing 18 for the shaft 12 of rotor 11, along with safety bearings 19 and 20. Radial position sensors 21 and an axial position sensor 22 are used to acquire the position of the shaft 12 relative to the upper or lower carrier sleeve 14 or 15, which is required for regulating the bearings. Finally, a housing 23 for the FESS 10 is also schematically shown.

The components of the magnetic bearing system secured on the shaft 12, i.e., on the rotor 11, are usual, and are schematically illustrated on FIG. 5, but not designated in any more detail; an in-depth explanation of these components need also not be provided in this regard.

The shaft 12 is preferably designed as a solid shaft, so that it can serve as a supporting structure for the required bearing and motor/generator components, as well as a bearing surface for the safety bearings 19, 20.

The flywheel 13 or its rotating element 13′ (FIG. 6) with its radially outer flywheel mass member 24 consists of a composite material.

The rotor 11 rotates inside the housing 23, which is vacuum-sealed and evacuated, and which also serves as a carrier for the stator components (see carrier sleeves 14, 15), around the X-X axis. As mentioned, the carrier sleeves 14, 15 have attached to them the stator sheets of the bearing and electric machine, windings along with sensors 21 and 22.

FIG. 6 shows the rotor 11 of the FESS system 10 according to FIG. 5 in a cut open, three-dimensional view. As especially clear here, in addition to the axial sectional view according to FIG. 5, the flywheel mass member 24 is designed with a tapering or indentation 25 on the outer contour, thus making the flywheel resemble a threaded spool, for example, or flywheel 13 as particularly evident from FIG. 6.

Suitable for manufacturing such a rotor 11 with flywheel 13 is a known winding method, in which the fibers (carbon fibers, glass fibers) are guided through an impregnating bath and then deposited wet upon a rotating core. A fiber angle of 90° relative to the X-X axis of rotation is ideal as regards the strength of the rotor 11. As an alternative, use can also be made of pre-impregnated fibers, so-called prepregs.

As further evident from FIG. 5, the rotor 11 does not absolutely have to be symmetrical in design relative to its central plane Y-Y (at a right angle to the rotor axis X-X), even if this will often be preferred. Such an asymmetrical configuration may make sense when special space requirements must be considered in terms of accommodating the individual motor/generator components, etc.

The described and illustrated tapering or indentation of the flywheel running all around in the circumferential direction makes it possible to achieve a significant improvement in material utilization.

In a depiction similar to FIG. 1B and FIG. 3B, FIG. 7 presents a schematic view of a quadrant of the flywheel 13 in an axial section. As evident, the rotor geometry consists of circular segments Kn and lines Gn (with n=1, 2 . . . ), and exhibits a tapering 25 of the outer contour. The smaller outer radius r in the area of the central plane Y-Y causes the moment of inertia to drop to 10.93 kgm². However, given the lower mass forces in this area, the radial stresses also drop, thereby enabling higher angular velocities (2188 rad/s). As a consequence, the rotor 11 has an energy content of 6.55 kWh, and at a mass also of 260 kg, an energy density of 24.58 Wh/kg is obtained. However, it would here be desirable (see recorded “load lines”) to make the hollow cylindrical areas defined by the projecting, axially parallel end pieces 24′ more efficient, i.e., expose them to a higher load.

The advantages to the invention can be used to an even greater extent by inclining the projecting parts 24′ as shown on FIG. 8. The inclination “alleviates” the bending stresses at the transition from the inner joining part 26 to the (actual) flywheel mass member 24. As a result, the radial stresses decrease, and the circumferential stresses increase, which in light of the material orientation yields a more favorable stress state and improved material utilization. At about the same angular velocity as for the rotor 11 according to FIG. 7 (2151 rad/s), the moment of inertia for the rotor 11 according to FIG. 8 measures 14.9 kgm², which corresponds to an energy content of 8.27 kWh. An energy density of 31.18 Wh/kg is obtained at the same mass, which represents a significant rise in comparison to the other structures.

This may be gleaned in particular from the schematic view on FIG. 9, in which the four previously cited rotor structures according to FIGS. 1B, 3B, 7 and 8 are contrasted with each other, and in which the energy content 30 and energy density 31 are illustrated. As evident, a 65% rise in energy density 31, for example, can be achieved in this exemplary configuration for the embodiments according to the invention, i.e., according to FIGS. 7 and 8.

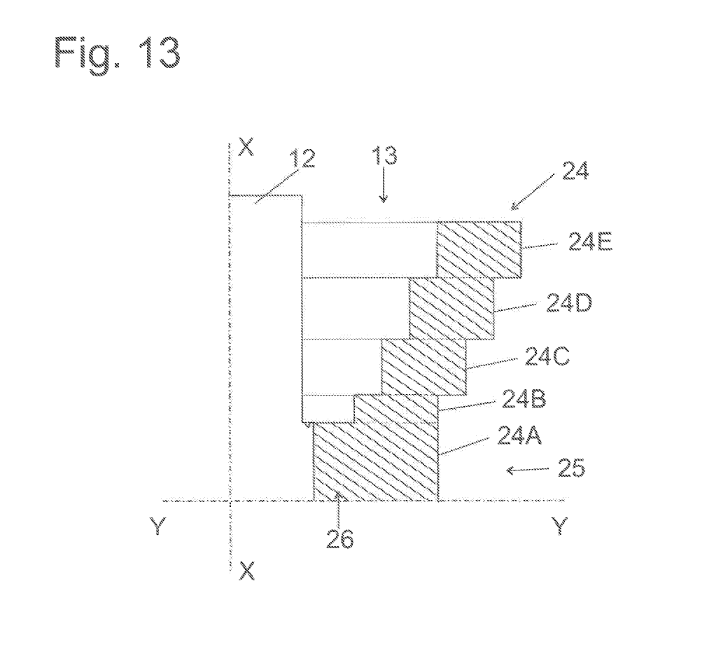

In the previously shown images, the rotor contour is always composed of straight segments Gn and circular segments Kn. However, discontinuous progressions or curves of a higher order, as e.g. ellipses, polynomials, etc. may be advantageous for functional (transport restraints, etc.) and/or manufacturing reasons; for example, see the embodiments according to FIGS. 10 to 12 and 14. The flywheel mass member 24 is cascading on FIG. 13, for example comprised of individually wound composite rings 24A-24E. These rings 24A-24E can be separately fabricated and assembled later. This yields a cascading contour of the kind visible on FIG. 13. Very generally, a cascading design, whether as a single piece or with separate rings, simplifies production, since the fibers cannot slide off the bobbin core in the winding process.

In any event, one essential advantage to be noted from the images according to FIGS. 7, 8 and 10 to 14 is that the tapering 25 of the outer contour leads to an improved stress state in terms of material orientation. The radial stresses are diminished, so that the circumferential stresses are increased.

An additional advantage to the rotor structures according to FIGS. 8 and 10 to 14 is that the “inclination” of the inner contour leads to an even better stress distribution at the transition to the inner “disk”, and hence to lower bending stresses. In addition, this makes it possible to increase the inertial radius, so that a higher energy content is achieved at the same mass.

The thickness selected for the “projecting” member 24′ (FIGS. 7, 8 and 10 to 14) must be large enough to achieve high rigidities, and thus high flexible characteristic frequencies. The contour of the rotor 11 must be selected in such a way as to maximize the energy density. Production-related limits are here in place. Proceeding from the load state shown on FIG. 3B for the H-shaped flywheel that can be fabricated with simple production means, it makes sense with respect to geometric optimization already from strictly a graphic standpoint that the flywheel member designed as a hollow cylinder be configured as a double hollow cone or given a shape resembling a hollow cone (see FIG. 8, etc.). This increases the inertial radius and reduces the bending stresses at the transition from the inner disk 26 to the outer flywheel mass member 13.

The strong anisotropy resulting from the lamellar molecular buildup of carbon fibers yields a low strength for the composite material transverse to the fiber direction, so that only low radial stresses are permissible. The very high radial stresses owing to the mass forces at the required maximum speeds can be reduced by smaller wall thicknesses. This yields a more favorable stress state, since the circumferential stresses rise, and the strength in this direction is significantly higher. However, lower wall thicknesses also lead to lower characteristic frequencies. In flywheel applications with a low motor power, operation beneath flexible characteristic features is intended, since it is critical to run through the characteristic rotor frequencies given the time required for that purpose. A fiber angle deviating from 90° can bring about an additional rigidity in the direction of the X-X axis. A compromise must here be found between strength and dynamic requirements.

In light of the enumerated advantages, better material utilization allows the invention to increase the energy density, and hence lower material costs by comparison to conventional rotor structures.

The significantly better material utilization, up to and including a “fully-stressed design”, makes it possible to significantly reduce the investment costs due to the higher energy density on the one hand, and to increase the overall energy efficiency on the other, making highly efficient flywheels economically feasible for use in a wide range of applications. The basic objective function is to minimize the mass at a given energy content, and to maximize energy efficiency. This ideally yields a geometry in which each area is exposed to a maximum load according to a suitable failure criterion, thus resulting in the best possible material utilization.

The composite material cited above (CFK or combinations of CFK-GFK) exhibits a strong anisotropy, but also outstanding material properties in the fiber direction. Mere glass fiber composites (GFK) are less anisotropic, and also more cost-effective. However, their rigidity properties and especially their densities are less ideal for flywheel applications by comparison to CFK.

A “concentric runout” of the rotor, i.e., the balancing quality, has an important influence on the arising bearing forces of the rotor, or on the required air gap during the magnetic bearing of the rotor, and hence on the energy efficiency of the overall system, which holds true to a special extent for the present flywheels with the mentioned high speeds. Positioning the balancing weights in areas with high radial stresses detracts from strength. This hampers assembly, since notches or a weakened material must be avoided. In addition, it would have to be ensured that the applied balancing weights remain at exactly the same location for the entire lifecycle.

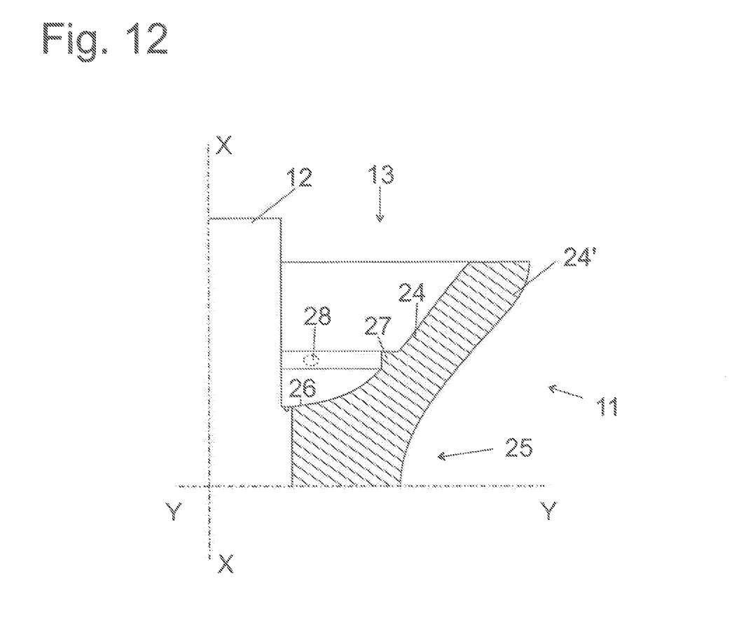

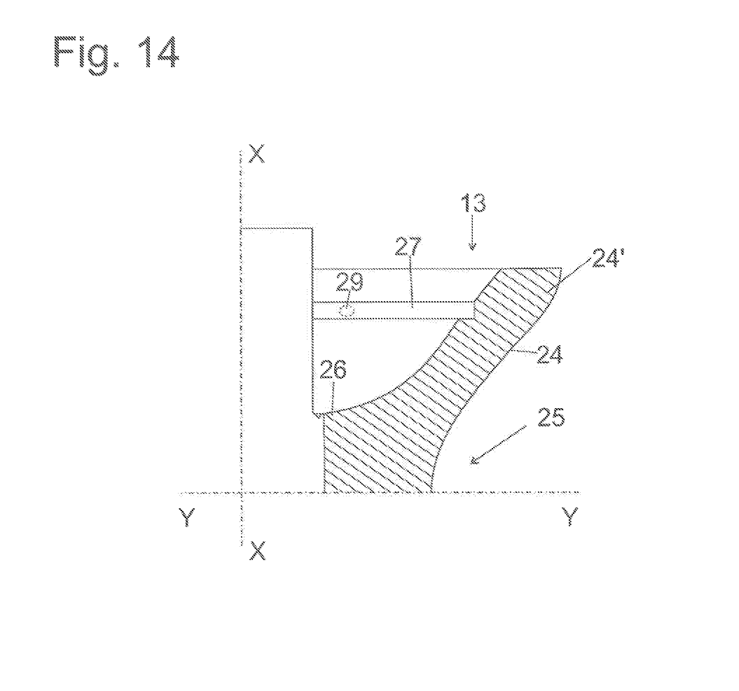

In order to resolve these problems, the present flywheel 13 can integrate special rings 27 (e.g., see FIGS. 12, 14) that accommodate balancing weights in the composite flywheel 13 and exhibit moldings or receptacles 28 for balancing weights, such as boreholes (see FIG. 12). At the required location, the latter are partially or completely filled with material. As an alternative, material removal (see FIG. 14) from the ring 27 is also possible to even out an imbalance. The placement of balancing weights is optimally integrated into the rotor structure taking into account production-related limits.

FIG. 15 shows a simulation of an exemplary rotor 11 with a balancing ring 27 made out of epoxy resin secured on the inside. Lines with the same failure criterion remain roughly unchanged, i.e., the ring 27 can be advantageously integrated at this location.

The ring 27 can exhibit different embodiments (see FIGS. 12, 15 and 16), and also be attached only after the rotor has been manufactured (e.g., FIGS. 12 and 14).

Even though the invention was described above based upon preferred exemplary embodiments, further modifications and variations are possible within the scope of the claims. In particular, it is also conceivable to provide the present flywheel in conjunction with an external rotor 11′ (see FIG. 17 in conjunction with FIG. 4), wherein it would even be conceivable to integrate the actual flywheel, i.e., the flywheel mass member 24, with the hollow shaft 12′ to which are secured the required components of the electrical machine and of the bearing, to yield a uniform component made of composite material. Materials other than CFK and GFK are also possible, for example polyethylene fibers, etc.

1-15. (canceled)

16. A flywheel with a rotating element that rotates in relation to an axis of rotation (X-X), which exhibits a radially outer flywheel mass member that tapers in a radial direction and adjoins an inner shaft connection part, wherein hollow projecting end pieces are formed, wherein an external face of the outer flywheel mass member exhibits a radial indentation that extends all around.

17. The flywheel of claim 16, wherein the outer flywheel mass member comprises legs that generally extend outwardly at an inclination away from a center of the indentation on opposite sides as viewed in axial section.

18. The flywheel of claim 16, wherein at least one area of the projecting end pieces runs axially parallel, and thereby defines a hollow cylinder.

19. The flywheel of claim 16, wherein the outer flywheel mass member exhibits a generally hollow cylindrical shape where it axially adjoins the indentation.

20. The flywheel of claim 16, wherein the shaft connection part exhibits a smaller axial extension than the outer flywheel mass member.

21. The flywheel of claim 16, wherein an outside and/or inside of the flywheel mass member exhibits a contour with one or more straight segments.

22. The flywheel of claim 16, wherein an outside and/or inside of the flywheel mass member exhibits a contour with one or more curved segments.

23. The flywheel of claim 22, comprising at least one circular arc segment.

24. The flywheel of claim 22, comprising at least one segment that runs along a higher-order curve.

25. The flywheel of claim 24, wherein the higher-order curve is an ellipsis or polynomial curve.

26. The flywheel of claim 16, wherein an outside and/or inside of the flywheel mass member exhibits a stepped contour.

27. The flywheel of claim 26, wherein the flywheel mass member is comprised of separate rings joined to each other.

28. The flywheel of claim 16, wherein the flywheel mass member comprises at least one ring with receptacles for the mounting of balancing weights.

29. The flywheel of claim 28, wherein the receptacles are boreholes.

30. The flywheel of claim 16, wherein the flywheel mass element is asymmetrical in design in the axial direction.

31. The flywheel of claim 16, comprising a fiber composite material.

32. The flywheel of claim 31, wherein the composite material is a CFK material.
